(19) United States
(12) Patent Application Publication
(10) Pub. No.: US 2025/0217868 A1
(43) Pub. Date: Jul. 3, 2025

(54) SMART SHOPPING METHOD

(71) Applicant: Leola Green, Yucaipa, CA (US)

(72) Inventor: Leola Green, Yucaipa, CA (US)

(21) Appl. No.: 18/399,289

(22) Filed: Dec. 28, 2023

(51) Int. Cl. G06Q 30/0601; G06Q 10/087; G06Q 20/20

(52) U.S. Cl. CPC G06Q 30/0635; G06Q 10/087; G06Q 20/208

(57) ABSTRACT

A smart offline shopping method for improving the offline shopping experience includes obtaining a shopping cart assembly. The shopping cart assembly includes an in-store shopping cart and a wireless computing device. The wireless computing device wirelessly communicates with a point-of-sale device and an inventory management system of a store. The wireless computing device temporarily retains a purchase order and communicates the purchase order to each of the point of sale device and the inventory management system. A customer may input an identification code associated with an item into the wireless computing device and add the item to the purchase order. An employee may fill the purchase order by gathering the item from an inventory stock room. An employee may bring the filled purchase order to the point-of-sale device, where the customer pays for the purchase order before leaving the store.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shopping methods and more particularly pertains to a new shopping method for improving the offline shopping experience.

### (2) Description of Related Art Including Information Disclosed Under 37 CFR 1.97 and 1.98

The prior art relates to shopping methods. More specifically, the prior art relates to offline shopping methods used in physical stores. One issue customers may face when shopping in person is that the products may have ingredient information or price information written in small font. This small font can make it difficult for customers to view the product information, particularly if the customer has poor eyesight. Another issue is that products are removed from the display shelves for purchase. After all of the products have been removed from the display shelves, subsequent customers are either unable to view and purchase the product or need an employee's assistance obtaining the product from the inventory stock room. Products can also be temporarily removed from the display shelving and misplaced throughout the store, which can cause confusion for both customers and employees. Because enough individual items of each product need to be stored on the display shelving for customers to purchase, the display shelving may not have enough space to display a variety of options for different brands or versions of various products. This can lead to discontent among customers, who may desire more options than a display shelf can provide. Some items are stored in display shelving with glass casings, particularly when those items are often stolen. However, a customer needs assistance from an employee in unlocking the glass casing to remove those items from the display shelving for purchase. Thus, there is a need in the art for a more secure shopping method that facilitates more effective use of display shelving and improved visibility of the items and product information for customers.

### BRIEF SUMMARY OF THE INVENTION

An embodiment of the disclosure meets the needs presented above by generally comprising obtaining a shopping cart assembly. The shopping cart assembly may include an in-store shopping cart and a wireless computing device that is coupled to the in-store shopping cart. The wireless computing device is configured to wirelessly communicate with a point-of-sale device of the store. The wireless computing device is further configured to wirelessly communicate with an inventory management system of the store. The wireless computing device is further configured to temporarily retain a purchase order of the customer and to wirelessly communicate the purchase order to each of the point of sale device and the inventory management system. A customer may input an identification code associated with an item that is offered for sale into the wireless computing device and add the item to the purchase order. An employee may fill the purchase order by gathering the item from an inventory stock room. An employee may bring the filled purchase order to the point-of-sale device, where the customer pays for the purchase order before leaving the store.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a smart offline shopping method according to an embodiment of the disclosure.

FIG. 2 is a side view of an embodiment of the disclosure.

FIG. 3 is a front view of an embodiment of the disclosure.

FIG. 4 is a back view of an embodiment of the disclosure.

FIG. 5 is an in-use view of an embodiment of the disclosure.

FIG. 6 is an isometric view of an embodiment of the disclosure.

FIG. 7 is a back view of an embodiment of the disclosure.

FIG. 8 is a detail view of an embodiment of the disclosure.

FIG. 9 is a detail view of an embodiment of the disclosure.

### DETAILED DESCRIPTION OF THE INVENTION

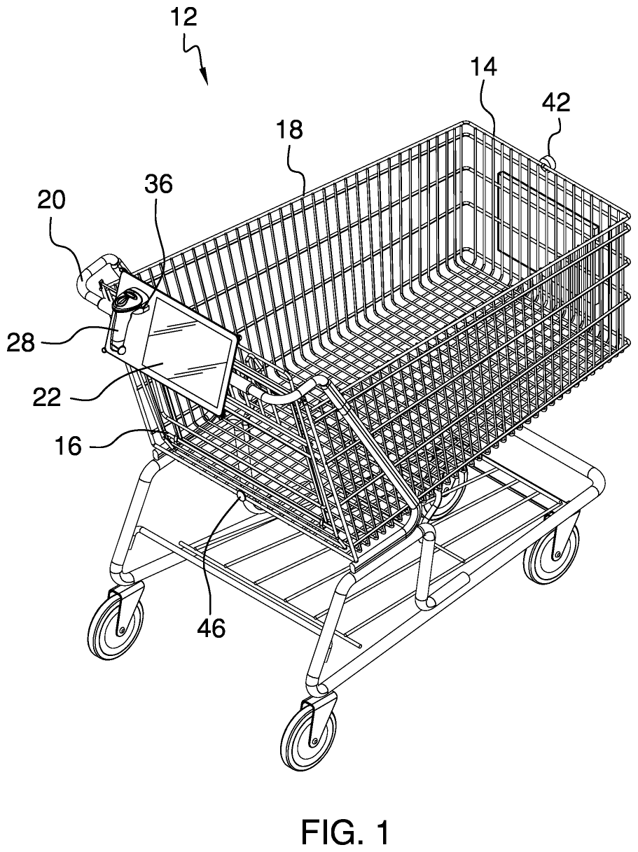

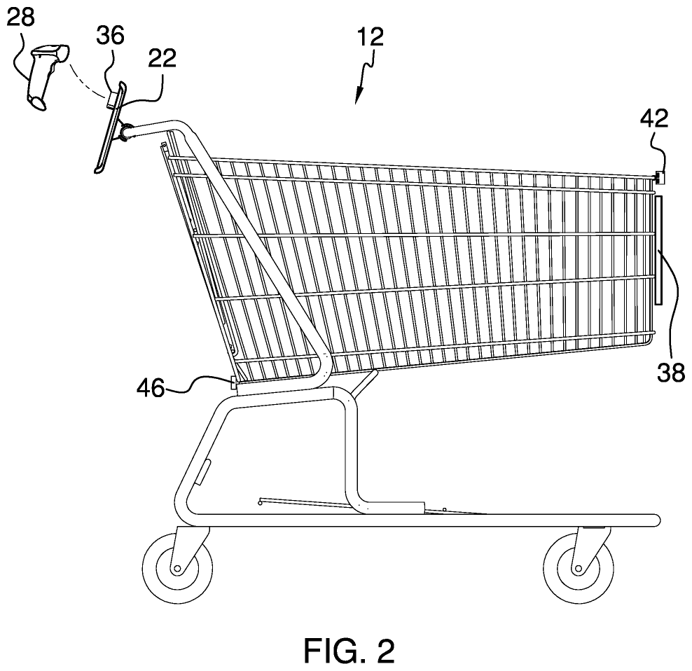

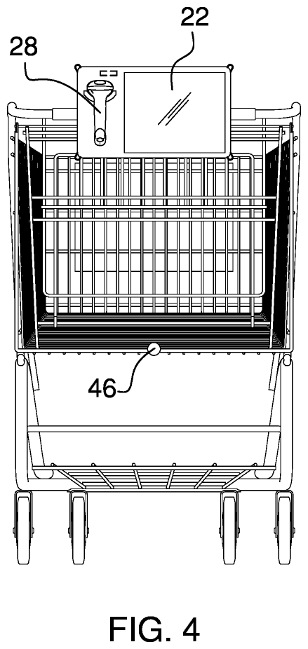

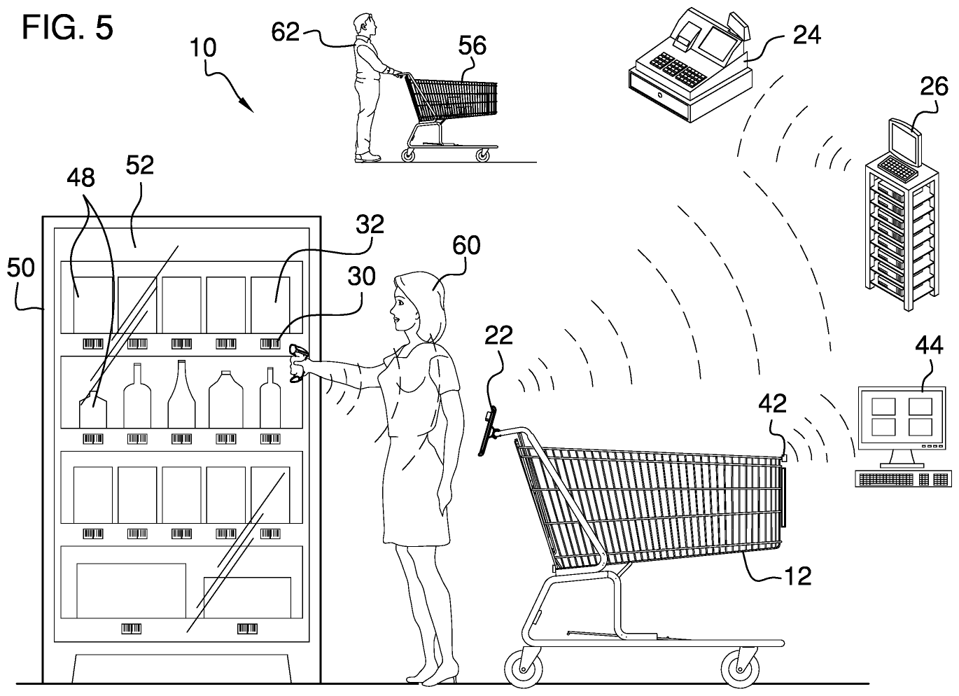

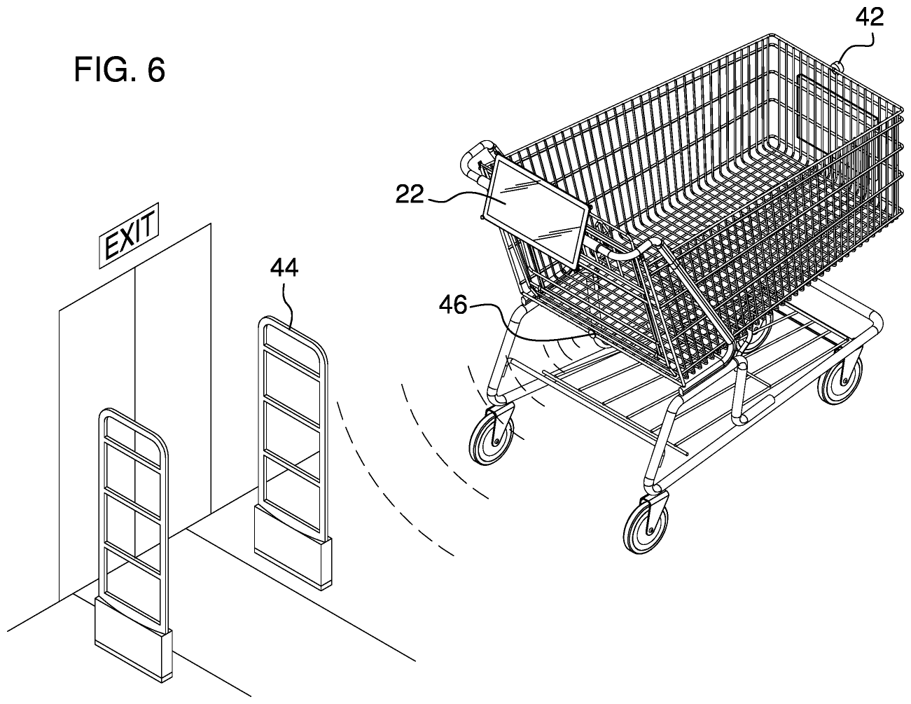

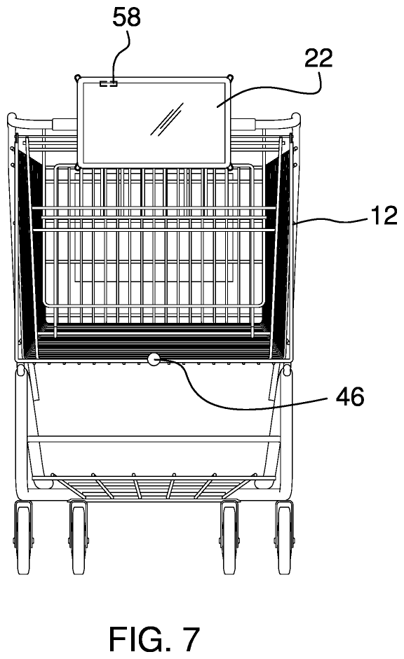

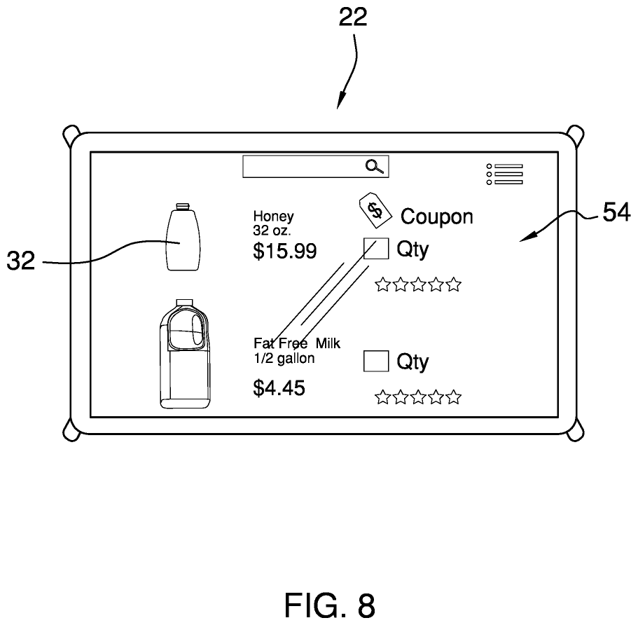

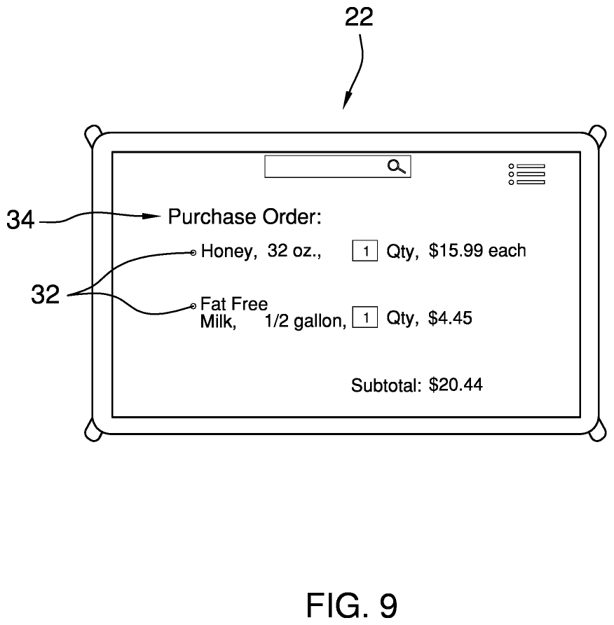

With reference now to the drawings, and in particular to FIGS. 1 through 9 thereof, a new shopping method embodying the principles and concepts of an embodiment of the disclosure and generally designated by the reference numeral 10 will be described.

As best illustrated in FIGS. 1 through 9, the smart offline shopping method 10 generally comprises obtaining a shopping cart assembly. The shopping cart assembly may comprise an in-store shopping cart 12. As used in this specification, the in-store shopping cart 12 may include any device a customer 60 would typically use for carrying items around a store while the customer 60 is shopping. For example, the in-store shopping cart 12 may comprise a basket, a bag, or a wheeled cart like the one shown in the drawings. In some embodiments, the in-store shopping cart 12 may have a front side 14, a back side 16, and a peripheral side 18 that is attached to and extends between the front side 14 and the back side 16.

A handle 20 may be attached to the in-store shopping cart 12. For example, the handle 20 may be positioned on the back side 16. The handle 20 is generally configured for gripping by the customer 60 when the customer 60 is moving the in-store shopping cart 12 through the store.

A wireless computing device 22 is generally coupled to the in-store shopping cart 12. For example, the wireless computing device 22 may comprise a tablet that is coupled to the handle 20. The wireless computing device 22 is configured to wirelessly communicate with a point-of-sale device 24 of the store and with an inventory management system 26 of the store.

A scanner 28 associated with the in-store shopping cart 12 may be electronically coupled to the wireless computing device 22. For example, the scanner 28 may be physically coupled to the in-store shopping cart 12, or removably couplable with the in-store shopping cart 12. Some embodiments include a cradle 36 that is coupled to the handle 20 and that has a shape that is configured to receive and retain the scanner 28 on the handle 20. The scanner 28 is configured to electronically communicate with the wireless computing device 22. The scanner 28 is also configured to read a barcode 30 associated with an item 32 that is offered for sale by the store.

The wireless computing device 22 is configured to temporarily retain a purchase order 34 of the customer 60. The item 32 may be added to the purchase order 34 after the scanner 28 reads the barcode 30. Alternatively, the customer 60 may add the item 32 directly to the purchase order 34 using the wireless computing device 22, for example by searching for the item 32 on the wireless computing device 22. The wireless computing device 22 wirelessly communicates the purchase order 34 to each of the point-of-sale device 24 and the inventory management system 26. The wireless computing device 22 may have a charging port 58 being configured to receive a power cord for recharging a power source of the wireless computing device.

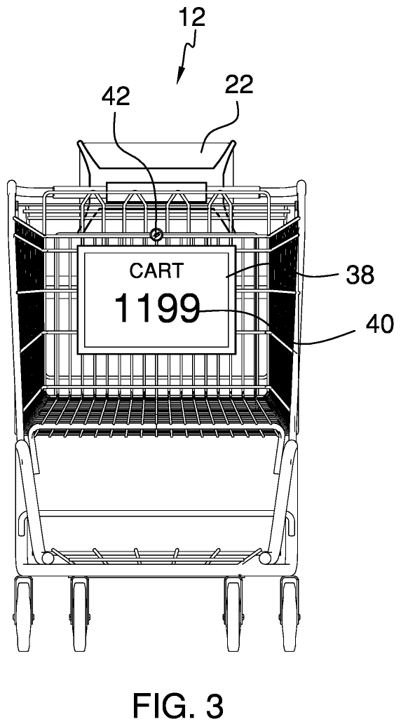

An identification plate 38 may be coupled to the in-store shopping cart 12. The identification plate 38 has an identifying indicia 40 printed thereon whereby the identification plate 38 is configured to identify the in-store shopping cart 12. For example, the identifying indicia 40 may comprise one or more of a cart number, a graphic, a color, or combinations thereof that distinguish the in-store shopping cart 12 being used by the customer 60 from other carts being used by other individuals within the store. In the example shown in FIG. 3, the identification plate 38 is positioned on the front side 14 of the in-store shopping cart 12.

A camera 42 may be coupled to the in-store shopping cart 12. The camera 42 is in wireless electronic communication with a security system 44 of the store. The camera 42 may be positioned on the front side 14 of the in-store shopping cart 12. The camera 42 may be positioned to monitor the customer 60 while the customer 60 is shopping, and is thereby configured to inhibit theft and other inappropriate behavior.

A sensor 46 may be coupled to the in-store shopping cart 12. The sensor 46 is generally in wireless electronic communication with the security system 44 of the store whereby the sensor 46 is configured to inhibit the in-store shopping cart 12 from exiting the store. For example, the sensor 46 may wirelessly communicate with the security scanners at the doorways of the store to actuate the security alarm if the customer 60 tries to leave the store with the in-store shopping cart 12. The scanner 46 thereby inhibits theft of the in-store shopping cart 12 and the wireless computing device 22.

The smart offline shopping method 10 may further comprise viewing a plurality of sample items 48 that are stocked on a shelving unit 50. The shelving unit 50 may only have a single article of each of the plurality of sample items 48, for example to increase the number of different items that are displayed and offered for sale. The shelving unit 50 may also have an outer casing 52 whereby the plurality of sample items 48 are enclosed within to the shelving unit 50. The plurality of sample items 48 are generally visible through the outer casing 52. The outer casing 52 may inhibit the article of the plurality of sample items 48 from being removed from the shelving unit 50.

The customer 60 may choose the item 32 the customer 60 is considering for purchase from the plurality of sample items 48 and scan the barcode 30 that is associated with the item 32 using the scanner 28. Alternatively, the customer 60 may search for the item 32 using the wireless computing device 22, for example using an item number that is associated with the item 32. The item number may be displayed on the shelving unit 50 along with the item 32 and the barcode 30.

The customer 60 may view information 54 about the item 32 with the wireless computing device 22. For example, the information 54 may include one or more of a price, an ingredient list, an image, a customer rating, an in-store availability, and a coupon. The customer 60 can thus view the information 54 in a font size that is convenient for the customer 60. This aspect of the invention may be particularly useful for individuals who struggle to read small or finely printed text, or who are interested in knowing what ingredients are included in the item 32.

Using the wireless computing device 22, the customer 60 can add or remove the item 32 from the purchase order 34. The purchase order 34 may be conveyed to the inventory management system 26 via wireless electronic communication from the wireless computing device 22. The purchase order 34 and the inventory management system 26 may be viewable by an employee 62 in the inventory stock room of the store. The purchase order 34 may also be conveyed to the point-of-sale device 24, for example by the wireless computing device 22.

For example, an employee 62 may view the purchase order 34 on the inventory management system 26. The employee 62 may fill the purchase order 34 by gathering the item 32 from the inventory stock room. The item 32 may be packed into a packable shopping cart 56. Generally, the packable shopping cart 56 does not include the wireless computing device 22 or the scanner 28. However, like the in-store shopping cart 12, the packable shopping cart 56 may include any device a customer 60 would use to transport purchased items out of the store, such as a bag, a basket, a box, or a wheeled cart. As used in this specification, the term “shopping cart” is meant to be illustrative rather than limiting. Unlike the in-store shopping cart 12, the packable shopping cart 56 is configured to exit the store, for example so that the customer 60 or the employee 62 can transport the item 32 to a vehicle of the customer 60.

The packable shopping cart 56 may be tagged with the identifying indicia 40 and brought out to the customer 60. For example, the packable shopping cart 56 may be used to transport the item 32 to the point-of-sale device 24 where the customer 60 can complete the purchase and pay for the purchase order 34. To ensure that the customer 60 receives the correct purchase order 34, and not the items ordered by a different individual, the packable shopping cart 56 can be matched with the in-store shopping cart 12 using the identifying indicia 40. Once the customer 60 has paid, the item 32 can be transported out of the store using the packable shopping cart 56.

In use, the shelving unit 50 with the outer casing 52 and the separation of the customer 60 from the inventory can reduce theft or other losses from the store. The customer 60 can more easily view and consider various types or articles of the item 32 before purchase using the wireless computing device 22. The employee 62 can more efficiently manage their time by assisting the customer 60 and filling the purchase order 34 from the stock room, rather than pulling stock from the stock room to repeatedly fill the shelving unit 50.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shopping method comprising:
obtaining a shopping cart assembly, the shopping cart assembly comprising:
an in-store shopping cart;
a wireless computing device being coupled to the in-store shopping cart, the wireless computing device being configured to wirelessly communicate with a point-of-sale device of a store, the wireless computing device being configured to wirelessly communicate with an inventory management system of the store;
the wireless computing device being configured to temporarily retain a purchase order of the customer, the wireless computing device being configured to wirelessly communicate the purchase order to each of the point of sale device and the inventory management system;
inputting an identification code into the wireless computing device, the identification code being associated with an item being offered for sale;
adding the item to the purchase order;
wherein the customer of the store does one or more of obtaining the shopping cart assembly, inputting the identification code into the wireless computing device, and adding the item to the purchase order;
filling the purchase order by gathering the item from an inventory stock room, wherein an employee of the store fills the purchase order from the inventory stock room; and
paying for the purchase order at the point-of-sale device.

2. The shopping method of claim 1, the shopping cart assembly further comprising an identification plate being coupled to the in-store shopping cart, the identification plate having an identifying indicia printed thereon whereby the identification plate is configured to identify the in-store shopping cart, the identifying indicia comprising a cart number.

3. The shopping method of claim 2, further comprising:
packing the item into a packable shopping cart;
tagging the packable shopping cart with the identifying indicia;
bringing the packable shopping cart to the point-of-sale device; and
matching the packable shopping cart with the in-store shopping cart using the identifying indicia.

4. The shopping method of claim 1, the shopping cart assembly further comprising a camera being coupled to the in-store shopping cart, the camera being in wireless electronic communication with a security system of the store.

5. The shopping method of claim 1, the shopping cart assembly further comprising a sensor being coupled to the in-store shopping cart, the sensor being in wireless electronic communication with a security system of the store whereby the sensor is configured to inhibit the in-store shopping cart from exiting the store.

6. The shopping method of claim 1, the shopping cart assembly further comprising a scanner being electronically coupled to the wireless computing device, the scanner being configured to read a barcode associated with an item.

7. The shopping method of claim 6, further comprising scanning the barcode being associated with the item using the scanner.

8. The shopping method of claim 1, further comprising
viewing a plurality of sample items, the plurality of sample items being stocked on a shelving unit, the shelving unit having an outer casing whereby the plurality of sample items are enclosed within to the shelving unit, the plurality of sample items being visible through the outer casing; and
choosing the item from the plurality of sample items.

9. The shopping method of claim 1, further comprising viewing information about the item with the wireless computing device, the information including one or more of a price, an ingredient list, an image, a rating, and a coupon.

10. The shopping method of claim 1, further comprising removing the item from the purchase order.

11. The shopping method of claim 1, further comprising conveying the purchase order to an inventory stock room, wherein the wireless computing device wirelessly communicates the purchase order to the inventory management system being viewable in the inventory stock room.

12. The shopping method of claim 1, further comprising viewing the purchase order on the inventory management system.

13. The shopping method of claim 1, further comprising packing the item into a packable shopping cart.

14. The shopping method of claim 13, further comprising transporting the item out of the store using the packable shopping cart.

15. The shopping method of claim 1, further comprising conveying the purchase order to the point-of-sale device, wherein the wireless computing device wirelessly communicates the purchase order to the point-of-sale device.

16. A shopping method comprising:
obtaining a shopping cart assembly, the shopping cart assembly comprising:
an in-store shopping cart having a front side, a back side, and a peripheral side being attached to and extending between the front side and the back side;
a handle being attached to the in-store shopping cart, the handle being configured for gripping by a customer when the customer is moving the in-store shopping cart through a store;
a wireless computing device being coupled to the handle, the wireless computing device being configured to wirelessly communicate with a point-of-sale device of the store, the wireless computing device being configured to wirelessly communicate with an inventory management system of the store;
a scanner being electronically coupled to the wireless computing device, the scanner being configured to read a barcode associated with an item;
the wireless computing device being configured to temporarily retain a purchase order of the customer, the item being added to the purchase order after the scanner reads the barcode, the wireless computing device being configured to wirelessly communicate the purchase order to each of the point of sale device and the inventory management system;
a cradle being coupled to the handle, the cradle being configured to receive and retain the scanner on the handle;
an identification plate being coupled to the in-store shopping cart, the identification plate having an identifying indicia printed thereon whereby the identification plate is configured to identify the in-store shopping cart, the identifying indicia comprising a cart number, the identification plate being positioned on the front side;
a camera being coupled to the in-store shopping cart, the camera being in wireless electronic communication with a security system of the store and being configured to monitor the customer while the customer is in the store, the camera being positioned on the front side;
a sensor being coupled to the in-store shopping cart, the sensor being in wireless electronic communication with the security system of the store whereby the sensor is configured to inhibit the in-store shopping cart from exiting the store;
viewing a plurality of sample items, the plurality of sample items being stocked on a shelving unit, the shelving unit having an outer casing whereby the plurality of sample items are enclosed within to the shelving unit, the plurality of sample items being visible through the outer casing;
choosing the item from the plurality of sample items;
scanning the barcode being associated with the item using the scanner;
viewing information about the item with the wireless computing device, the information including one or more of a price, an ingredient list, an image, a customer rating, and a coupon;
adding the item to the purchase order using the wireless computing device;
removing the item from the purchase order using the wireless computing device;
wherein the customer of the store performs one or more of obtaining the shopping cart assembly, viewing the plurality of sample items, choosing the item from the plurality of sample items, scanning the barcode being associated with the item, viewing information about the item with the wireless computing device, adding the item to the purchase order, and removing the item from the purchase order;
conveying the purchase order to an inventory stock room, wherein the wireless computing device wirelessly communicates the purchase order to the inventory management system being viewable in the inventory stock room;
viewing the purchase order on the inventory management system;
filling the purchase order by gathering the item from the inventory stock room, wherein an employee of the store fills the purchase order from the inventory stock room;
packing the item into a packable shopping cart;
tagging the packable shopping cart with the identifying indicia;
conveying the purchase order to the point-of-sale device, wherein the wireless computing device wirelessly communicates the purchase order to the point-of-sale device;
paying for the purchase order at the point-of-sale device;
bringing the packable shopping cart to the point-of-sale device;
matching the packable shopping cart with the in-store shopping cart using the identifying indicia; and
transporting the item out of the store using the packable shopping cart.
